(19) United States
(12) Patent Application Publication
(10) Pub. No.: US 2020/0117979 A1
(43) Pub. Date: Apr. 16, 2020

(54) NEURAL NETWORK PROCESSING OF RETURN PATH DATA TO ESTIMATE HOUSEHOLD DEMOGRAPHICS

(71) Applicant: The Nielsen Company (US), LLC, New York, NY (US)

(72) Inventors: Jonathan Sullivan, Hurricane, UT (US); Joshua Ivan Friedman, New York, NY (US); Elise Braun, New York, NY (US); Paul Chimenti, Tampa, FL (US); Juan Guillermo Llanos, Chicago, IL (US); Ludo Daemen, Duffel (BE); Freddy Boulton, Cambridge, MA (US)

(21) Appl. No.: 16/230,620

(22) Filed: Dec. 21, 2018

Related U.S. Application Data
(60) Provisional application No. 62/743,925, filed on Oct. 10, 2018.

(51) Int. Cl. G06N 3/04; H04H 60/52; G06K 9/62; H04N 21/258

(52) U.S. Cl. CPC G06N 3/0472; H04H 60/52; H04N 21/25883; G06N 3/049; G06K 9/6267; G06N 3/0454

(57) ABSTRACT

Example methods, apparatus, systems and articles of manufacture (e.g., physical storage media) to implement neural network processing of set-top box return path data to estimate household demographics are disclosed. Example demographic estimation systems disclosed herein include a feature generator to generate features from return path data reported from set-top boxes associated with return path data households. Disclosed example demographic estimation systems also include a neural network to process the features generated from the return path data to predict demographic classification probabilities for the return path data households, the neural network to be trained based on panel data reported from meters that monitor media devices associated with panelist household. Disclosed example demographic estimation systems further include a demographic assignment engine to assign one or more demographic categories to respective ones of the return path data households based on the predicted demographic classification probabilities.

### RELATED APPLICATION(S)

This patent claims the benefit of and priority to U.S. Provisional Application Ser. No. 62/743,925, entitled “NEURAL NETWORK PROCESSING OF SET-TOP BOX RETURN PATH DATA TO ESTIMATE HOUSEHOLD DEMOGRAPHICS” and filed on Oct. 10, 2018. U.S. Provisional Application Ser. No. 62/743,925 is hereby incorporated by reference in its entirety.

### FIELD OF THE DISCLOSURE

This disclosure relates generally to neural networks and, more particularly, to neural network processing of return path data to estimate household demographics.

### BACKGROUND

Audience measurement entities (AMEs), such as The Nielsen Company (US), LLC, may extrapolate ratings metrics and/or other audience measurement data for a total television viewing audience from a relatively small sample of panel homes. The panel homes may be well studied and are typically chosen to be representative of an audience universe as a whole. Furthermore, to help supplement panel data, an AME, such as The Nielsen Company (US), LLC, may reach agreements with pay-television provider companies to obtain the television tuning information derived from set top boxes and/or other devices/software, which is referred to herein, and in the industry, as return path data.

### BRIEF DESCRIPTION OF THE DRAWINGS

FIG. 1 is a block diagram of an example processing flow to estimate demographic classification probabilities from set-top box return path data using a neural network in accordance with teachings of this disclosure.

FIG. 2 is a block diagram of an example processing flow to use the demographic classification probabilities estimated by the example processing flow of FIG. 1 to assign demographics to households in accordance with teachings of this disclosure.

FIG. 3 is a block diagram of an example neural-network-based demographic estimation system structured to implement the processing flows of FIGS. 1 and 2 to estimate household demographics from set-top box return path data in accordance with teachings of this disclosure.

FIGS. 4A-B illustrate example features generated by the example feature generator included in the example neural-network-based demographic estimation system of FIG. 3.

FIG. 5 is a block diagram of an example implementation of the example demographic prediction neural network included in the example neural-network-based demographic estimation system of FIG. 3.

FIGS. 6A-C illustrate an example operation of the demographic prediction neural network of FIG. 3 to estimate demographic classification probabilities from set-top box return path data in accordance with teachings of this disclosure.

FIG. 7 illustrates example pseudocode for implementing the example household demographic assignment engine included in the example neural-network-based demographic estimation system of FIG. 3.

FIGS. 8A-E illustrate an example operation of the household demographic assignment engine of FIG. 3 to assign demographics to households in accordance with teachings of this disclosure.

FIGS. 9A-C illustrate example simulated annealing operations that may be performed by the household demographic assignment engine of FIG. 3.

FIG. 10 is a flowchart representative of example computer readable instructions that may be executed to implement the neural-network-based demographic estimation system of FIG. 3.

FIG. 11 is a block diagram of an example processor platform structured to execute the example machine readable instructions of FIG. 10 to implement the example neural-network-based demographic estimation system of FIG. 3.

The figures are not to scale. In general, the same reference numbers will be used throughout the drawing(s) and accompanying written description to refer to the same or like parts, elements, etc.

### DETAILED DESCRIPTION

Example methods, apparatus, systems and articles of manufacture (e.g., physical storage media) to implement neural network processing of return path data to estimate household demographics are disclosed herein. Example of such demographic estimation systems disclosed herein include a feature generator to generate features from return path data reported from set-top boxes associated with return path data households. Example demographic estimation systems disclosed herein also include a neural network to process the features generated from the return path data to predict demographic classification probabilities for the return path data households. Example demographic estimation systems disclosed herein further include a demographic assignment engine to assign one or more demographic categories to respective ones of the return path data households based on the predicted demographic classification probabilities

These and other example methods, apparatus, systems and articles of manufacture (e.g., physical storage media) to implement neural network processing of return path data to estimate household demographics are disclosed in further detail below.

As noted above, AMEs extrapolate ratings metrics and/or other audience measurement data for a total television viewing audience from a relatively small sample of panelist households, also referred to herein as panel homes. The panel homes may be well studied and are typically chosen to be representative of an audience universe as a whole. However, accurately representing the geographic distribution and demographic diversity that exists in the total audience population with a small sample of panel homes remains a challenge. Incorporating additional streams of information about media exposure to the total audience population can fill in gaps or biases inherent to any statistical sample.

To help supplement panel data, an AME, such as The Nielsen Company (US), LLC, may reach agreements with pay-television provider companies to obtain the television tuning information derived from set top boxes, which is referred to herein, and in the industry, as return path data (RPD). Set-top box (STB) data includes all the data collected by the set-top box. STB data may include, for example, tuning events and/or commands received by the STB (e.g., power on, power off, change channel, change input source, start presenting media, pause the presentation of media, record a presentation of media, volume up/down, etc.). STB data may additionally or alternatively include commands sent to a content provider by the STB (e.g., switch input sources, record a media presentation, delete a recorded media presentation, the time/date a media presentation was started, the time a media presentation was completed, etc.), heartbeat signals, or the like. The set-top box data may additionally or alternatively include a household identification (e.g. a household ID) and/or a STB identification (e.g. a STB ID).

Return path data includes any data receivable at a media service provider (e.g., a such as a cable television service provider, a satellite television service provider, a streaming media service provider, a content provider, etc.) via a return path to the service provider from a media consumer site. As such, return path data includes at least a portion of the set-top box data. Return path data may additionally or alternatively include data from any other consumer device with network access capabilities (e.g., via a cellular network, the internet, other public or private networks, etc.). For example, return path data may include any or all of linear real time data from an STB, guide user data from a guide server, click stream data, key stream data (e.g., any click on the remote—volume, mute, etc.), interactive activity (such as Video On Demand) and any other data (e.g., data from middleware). RPD data can additionally or alternatively be from the network (e.g., via Switched Digital software) and/or any cloud-based data (such as a remote server DVR) from the cloud.

RPD can provide insight into the media exposure associated with a larger segment of the audience population. This is because RPD typically provides a rich stream of television viewing information for a much larger number of households than are included in an AME's panel homes. However, unlike the well-studied AME panel homes, the demographic details of pay-television subscribers are typically unknown. This lack of demographic details in the RPD can result in technical problems preventing, or at least limiting, the ability to effectively use RPD to supplement the AME's panel data because monitoring the behavioral profiles of various audience demographics requires knowledge of the demographic composition of the subscriber homes providing the RPD.

Neural network processing of set-top box RPD to estimate household demographics as disclosed herein provides a technical solution to the technical problem of combining RPD with panel data for audience measurement. As disclosed in further detail below, example neural-network-based demographic estimation systems implemented in accordance with teachings of this disclosure use panel data collected from monitored AME panel homes as a training set for training a neural network (e.g., a recurrent neural network) to be able to predict, from RPD tuning data describing historical television tuning behavior, probabilities of different household demographic characteristics being associated with respective ones of the RPD households reporting the RPD data. Disclosed example neural-network-based demographic estimation system predictions then use the predicted probabilities of different household demographic characteristics to assign demographic compositions to households. In this way, example neural-network-based demographic estimation systems assign demographic compositions to the subscriber homes providing the RPD, thereby allowing the RPD to be combined with or to otherwise enhance the panel data driving an AME's audience measurement systems.

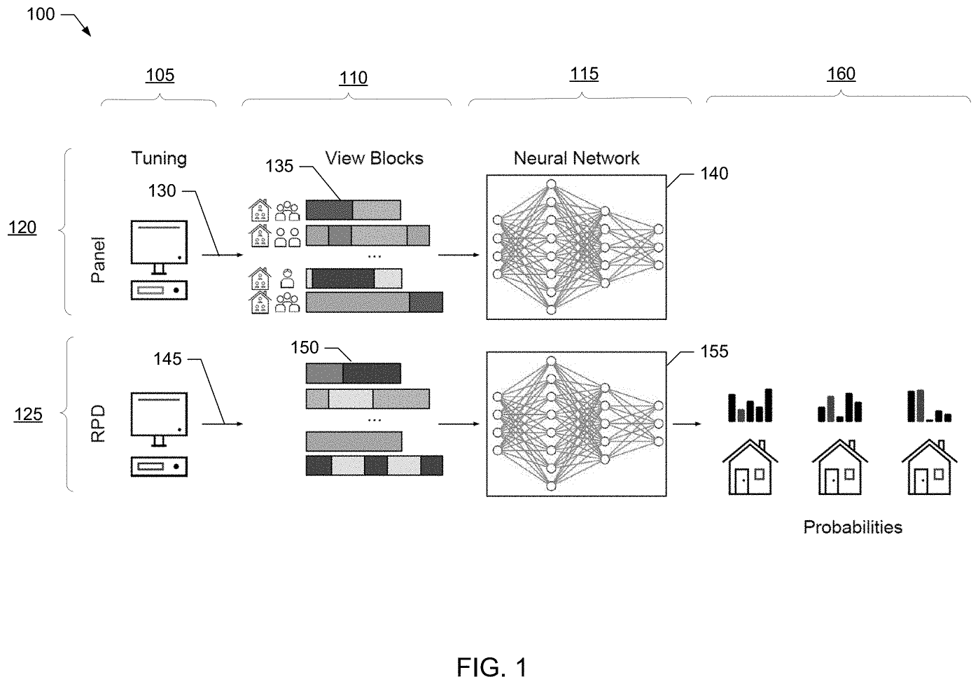

Turning to the figures, a block diagram of an example processing flow 100 to estimate demographic classification probabilities from set-top box RPD using a neural network in accordance with teachings of this disclosure is illustrated in FIG. 1. The example processing flow 100 includes an example data collection phase 105, an example feature generation phase 110 and an example neural network demographic probability prediction phase 115. The example processing flow 100 is further divided into an example neural network training branch 120 and an example neural network application branch 125.

In the data collection phase 105 of the neural network training branch 120, example panelist tuning data 130 is collected from meters monitoring media exposure in panel homes recruited by an AME. Panelist tuning data 130 can include any data collectable by the meters, such as, but not limited to, data identifying media presented by media devices in the panel homes, demographic data identifying characteristics of the panelists in the panel homes, etc. In the feature generation phase 110 of the neural network training branch 120, example features 135 are generated from the collected panelist tuning data 130 and arranged to form feature vectors, as described in further detail below. In the neural network demographic probability prediction phase 115 of the neural network training branch 120, a neural network is trained to predict, from the features 135 generated from the collected panelist tuning data 130, probabilities of different household demographic characteristics being associated with the different panel homes, as described in further detail below.

In the data collection phase 105 of the neural network application branch 125, example RPD tuning data 145 is collected from set-top boxes of one or more pay television providers (e.g., cable television service providers, satellite television service providers, streaming media service providers, content providers, etc.). A set-top box may also refer to any decoder, receiver, integrated receiver-decoder (IRD), media device, etc., from which the RPD tuning data 145 may be collected. In the feature generation phase 110 of the neural network application branch 125, example features 150 are generated from the collected RPD tuning data 145 and arranged to form feature vectors, as described in further detail below. In the neural network demographic probability prediction phase 115 of the neural network application branch 125, the trained neural network is applied to the features 150 generated from the collected RPD tuning data 145 to predict example estimated probabilities 160 of different household demographic characteristics being associated with the different RPD subscriber households that reported the RPD tuning data 145, as described in further detail below

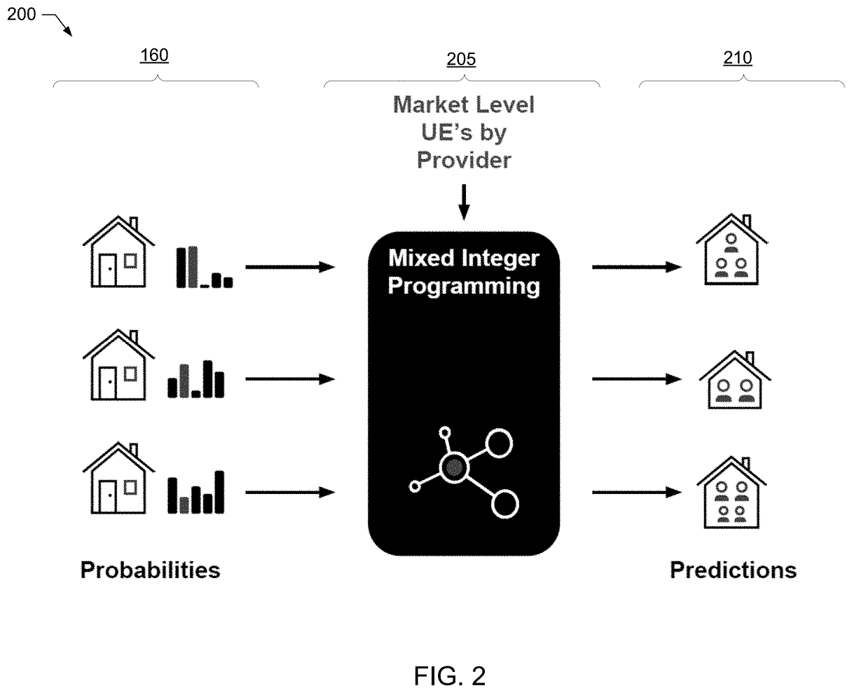

A block diagram of an example processing flow 200 to use the estimated demographic classification probabilities 160 predicted by the example processing flow 100 of FIG. 1 to assign demographics to households in accordance with teachings of this disclosure is illustrated in FIG. 2. As disclosed in further detail below, the processing flow 200 utilizes an example mixed integer programming solution 205, which solves a constrained optimization problem based on the estimated demographic classification probabilities 160 predicted by the example processing flow 100, to assign example, estimated demographic compositions 210 to the subscriber homes that provided the RPD tuning data 145.

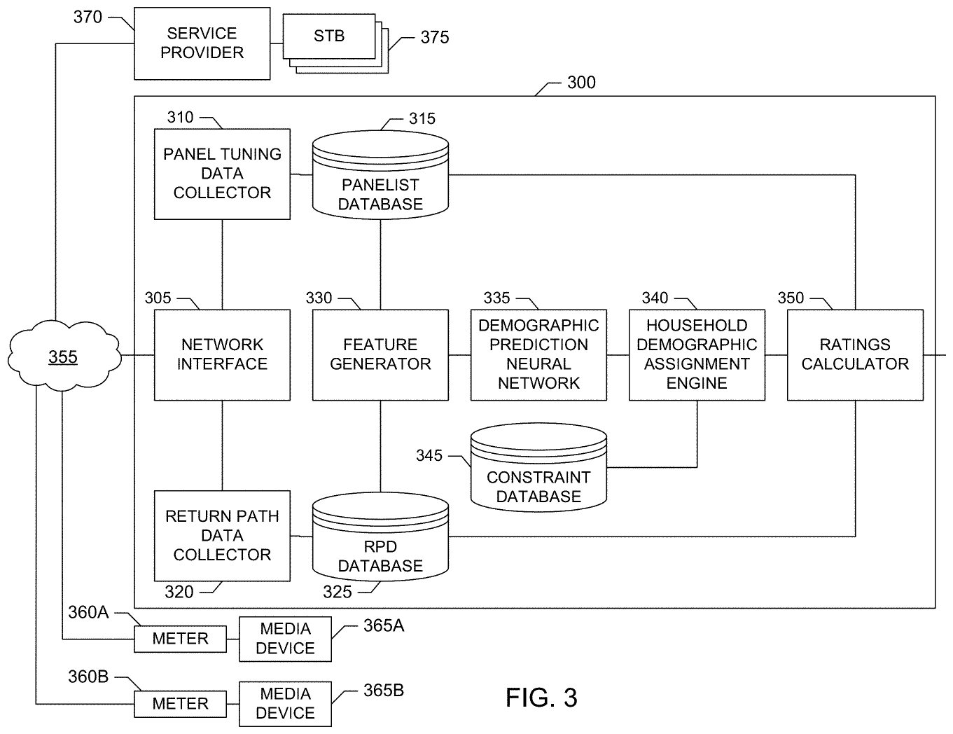

A block diagram of an example neural-network-based demographic estimation system 300 structured to implement the processing flows 100 and 200 of FIGS. 1 and 2, respectively, to estimate household demographics from set-top box RPD in accordance with teachings of this disclosure is illustrated in FIG. 3. The example neural-network-based demographic estimation system 300 includes an example network interface 305, an example panel tuning data collector 310, an example panelist database 315, an example RPD data collector 320, an example RPD database 325, an example feature generator 330, an example demographic prediction neural network 335, an example household demographic assignment engine 340, an example constraint database 345 and an example ratings calculator 350.

In the illustrated example, the panel tuning data collector 310 collects, via the network interface 305 in communication with one or more example networks 355, the panelist tuning data 130 from example meters 355A-B monitoring media exposure associated with example media devices 360A-B (e.g., televisions, radios, computers, tablet devices, smart phones, etc.) in panel homes recruited by an AME. The panel tuning data collector 310 stores the collected panelist tuning data 130 in the panelist database 315. In the illustrated example, the RPD data collector 320 collects, via the network interface 305 in communication with the one or more networks 355, the RPD tuning data 145 from one or more example service providers 370 that collect the RPD tuning data 145 from example individual STBs 375 in the subscriber households. Additionally or alternatively, in some examples, the RPD data collector 320 collects the RPD tuning data 145 from tone or more of the individual STBs 375 in the subscriber households directly via the network interface 305 in communication with the one or more networks 355. The RPD data collector 320 stores the collected RPD tuning data 145 in the RPD database 325.

The feature generator 330 of the illustrated example generates the features and feature vectors used by the example demographic prediction neural network 335. In some examples, RPD tuning data consists of sequential logs of when respective set top boxes were tuned to different stations. Individuals (e.g., audience members) transfer between multiple networks over the course of a contiguous television viewing session, and this pattern of activity may provide additional information about the household beyond the tuning record in isolation. To capture this behavior, the feature generator 330 compiles the STB records of television tuning into “view blocks” that aggregate the viewing behavior of one or more unknown viewers into a fixed number of features summarizing each contiguous viewing session. In some examples, view block durations are capped at 1 hour, or some other duration, to account for situations in which multiple viewers may take control of a television without necessarily turning the television off between sessions. In the illustrated example, each view block contains F features recording information about the start time of the view block, channel click rate, duration of the viewing sessions and a listing of the television stations visited during the session.

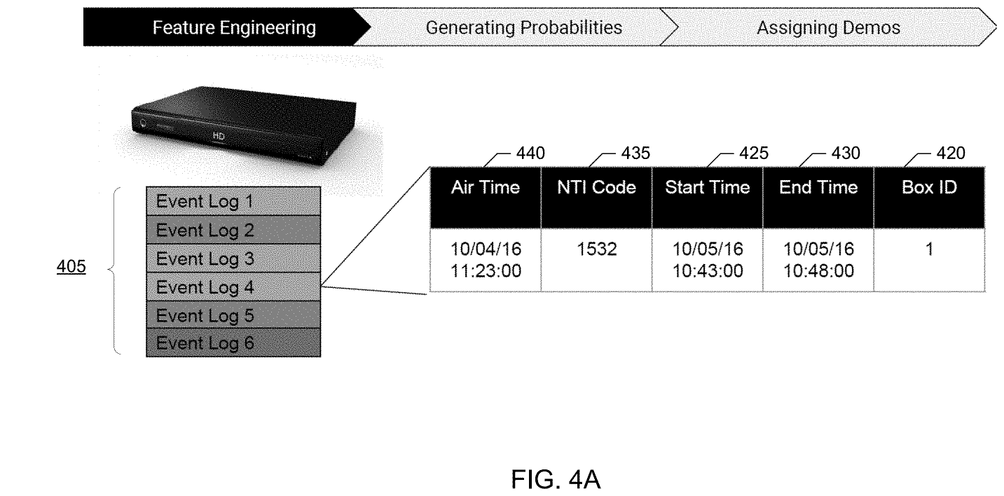

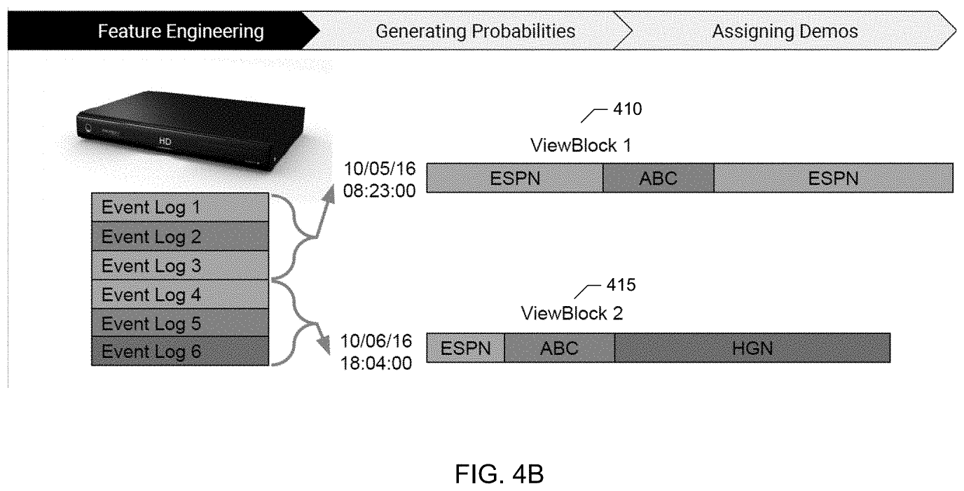

FIGS. 4A-B illustrate an example operation of the feature generator 330 to combine example RPD tuning data records 405 from the RPD tuning data 145 into corresponding example view blocks 410 and 415. In the illustrated example of FIG. 4A, respective ones of the data records 405 record tuning events reported by the STBs 375. A given data record 405 specifies an STB identifier STB ID) 420 identifying the STB corresponding to the event log, start and end times 425 and 430, respectively, corresponding to the tuning event represented by the event log, a source identifier (SID) 435 identifying the media source (e.g., channel number, station identifier, etc.) associated with the tuning event, and a broadcast time 440 identifying when the media associated with the tuning event originally aired (e.g., to distinguish between live and time-shifted tuning events). In the illustrated example of FIG. 4B, the view block 410 aggregates the tuning events recorded in the data records 405 for a given household and occurring in the hour interval beginning at 8:23 AM on Nov. 5, 2016. In the illustrated example of FIG. 4B, the view block 415 aggregates the tuning events recorded in the data records 405 for a given household and occurring in the hour interval beginning at 6:04 PM on Nov. 6, 2016.

The feature generator 330 of the illustrated example groups view blocks by household and a group of N view blocks is assembled into a two-dimensional (N×F) matrix containing a record of the view blocks generated by a household over a given observation period. In some examples, the feature generator 330 aggregates relevant household level features, including the number of television tuners, and the amount of television watched, with the view block data, into an H dimensional (1×H) additional feature vector for each household.

In some examples, each view block is a (1×173) feature vector describing a corresponding television viewing session. As such, the corresponding (N×F) matrix has an F dimension of 173 for this examples. Table 1 illustrates the contents of an example view block represented as a (1×173) feature vector.

TABLE 1

| Index | Short Description | Valid Range |
|---|---|---|
| 0 | Day of week | 0-6 |
| 1 | Day of Year | 0-364 |
| 2 | Quarter Hour of Day | 0-95 |
| 3 | Chanel Change Rate | 0-Inf |
| 4-173 | Minutes Each Network Was Viewed | 0-60 |

The first three features in Table 1 are self-explanatory. The “Channel Change Rate” feature of Table 1 is the ratio of the number of times the channel changed during the view block to the duration of the view block in minutes. The “Minutes Viewing Each Network” feature is the total number of minutes each television station was watched. In the example of Table 1, view blocks are capped at 60 minutes duration and, thus, the summation of these features over all networks is to be <=60.0 minutes. In some such examples, a viewing session may thereby be associated with one or more view blocks. In the example of Table 1, each station is randomly assigned an index value between 4 and 173.

In some examples, view blocks (from panel households) containing less than 5 minutes of television viewing behavior are not used to train the demographic prediction neural network 335. The view blocks for each household (e.g., panel households for neural network training and RPD households for neural network application) are then stacked into a two-dimensional matrix with, for example, 400 rows (e.g., N=400). In some examples, households that generated fewer than 400 unique view blocks are zero padded by the feature generator 330 until they have 400 rows, while those with greater than 400 are truncated by the feature generator 330 to the first 400 rows. The two-dimensional arrays from each household are then stacked by the feature generator 330 to forming a three-dimensional matrix that can be fed into the demographic prediction neural network 335.

In some examples, the feature generator 330 augments viewing data with three household level features, H, that are merged into the demographic prediction neural network 335 following a recurrent layer, as described below. Table 2 illustrates an example set of the three household level features, H, corresponding to (i) a total amount of tuning reported for the given household across the different durations of time covered by the view blocks (e.g., a 24 hour period) (corresponding to Index 0 in the table), (ii) a number of view blocks reported for the given household across the different durations of time (corresponding to Index 1 in the table), and (iii) a total number of tuners included in the first one of the return path data households (corresponding to Index 2 in the table).

TABLE 2

| Index | Short Description | Valid Range |
|---|---|---|
| 0 | Total TV Consumption (Minutes) | 1-Inf |
| 1 | Number of View Blocks Recorded | 1-Inf |
| 2 | Number of Television Tuners In House | 1-Inf |

In the illustrated example, the demographic prediction neural network 335 is structured to predict 20 variables (e.g., a 1×20 vector) representing probabilities of different household level demographics being present in a household (although other numbers of variables representing other demographics could additionally or alternatively be predicted in other example implementations of the demographic prediction neural network 335). In the illustrated example, fourteen household demographic target variables predicted by the demographic prediction neural network 335 indicate the respective probabilities (e.g., likelihoods) of 14 different age gender combinations being present in the household, examples of which are represented in Table 3.

TABLE 3

| Index | Age/Gender | |
|---|---|---|
| 0 | 0-12 | |
| 1 | 13-17 | |
| 2 | 18-24 | Male |
| 3 | 25-34 | Male |
| 4 | 35-44 | Male |
| 5 | 45-54 | Male |
| 6 | 55-64 | Male |
| 7 | 65+ | Male |
| 8 | 18-24 | Female |
| 9 | 25-34 | Female |
| 10 | 35-44 | Female |
| 11 | 45-54 | Female |
| 12 | 55-64 | Female |
| 13 | 65+ | Female |

In addition to the presence variables of Table 3, in some examples, the demographic prediction neural network 335 predicts six additional target variables describing the demographic profile of the head of household (HOH), examples of which are represented in Table 4.

TABLE 4

| Index | HOH Characteristics |
|---|---|
| 14 | HOH Age |
| 15 | HOH Gender |
| 16 | Hispanic Origin |
| 17 | European American |
| 18 | African American |
| 19 | Asian American |

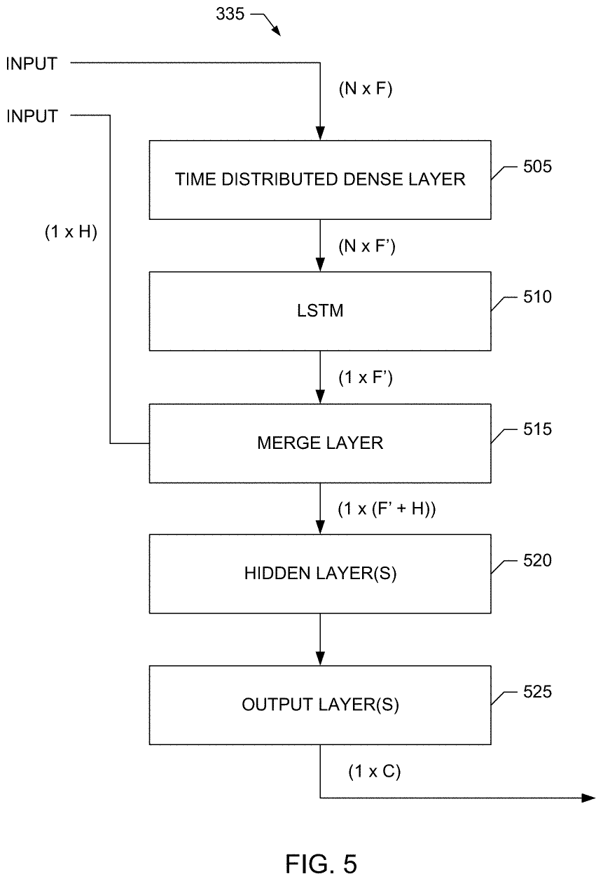

An example implementation of the demographic prediction neural network 335 of FIG. 3 is illustrated in FIG. 5. In some examples, the two-dimensional (N×F) feature vectors (e.g., 400×173 feature vectors) generated for respective ones of the households being processed (e.g., panel and/or RPD households) are typically sparse (for example, many broadcast networks that are represented in the feature vectors are never visited during a given view block). To condense this input into a smaller subset of features, the demographic prediction neural network 335 includes am example Time Distributed Dense Layer (TDDL) 505 that learns a single set of weights mapping each view block to a condensed representation of the input (N×F′ where F′<<F). This compressed data is then fed into an example Long Short Term Memory (LSTM) recurrent neural network layer 510. The LSTM 510 examines each row of the view block matrix in sequence and uses that information to selectively update a singular internal state vector that encodes information from each viewing session/view block. The output of the LSTM 510 is a one-dimensional (1×F′) feature vector that summarizes the history of evidence observed for each household. The example demographic prediction neural network 335 of FIG. 5 includes an example merge layer 515 to merge (concatenate) additional (1×H) household level features with the one-dimensional representation of the viewing data output from the LSTM 510. The additional (1×H) household level features include details about the total number of devices in the household, the total minutes watched over the observation window and total number of view blocks that were recorded for the particular household over the observation window, as described above.

In the example demographic prediction neural network 335 of FIG. 5, the augmented feature vector output from the merge layer 515 is passed to one or more additional example hidden layer(s) 520 before being output from an example output layer 525 as a (1×C) probability vector representing the respective predicted probabilities of the C possible demographic categories being present in the household. The C demographic classes modeled by the demographic prediction neural network 335 need not be mutually exclusive (e.g., households may contain multiple people of different age/genders) so the output vector encodes the relative probability each modeled household level demographic is present in the unknown household.

Table 5 lists example dimensions of the data at each stage of the example demographic prediction neural network 335 of FIG. 5. In Table 5, N is the total number of view blocks per household, F the number of features in each view block, F′ the number of dense features generated by the TDDL 505 and H the number of additional household specific features.

TABLE 5

| Dimension | Number of Nodes |
|---|---|
| M | 3 |
| N | 400 |
| F | 173 |
| F′ | 30 |
| C | 20 |

In some examples, to prevent the demographic prediction neural network 335 from over-fitting, and enable it to better generalize, the feature generator 330 shuffles the order of blocks fed into demographic prediction neural network 335 during each training epoch.

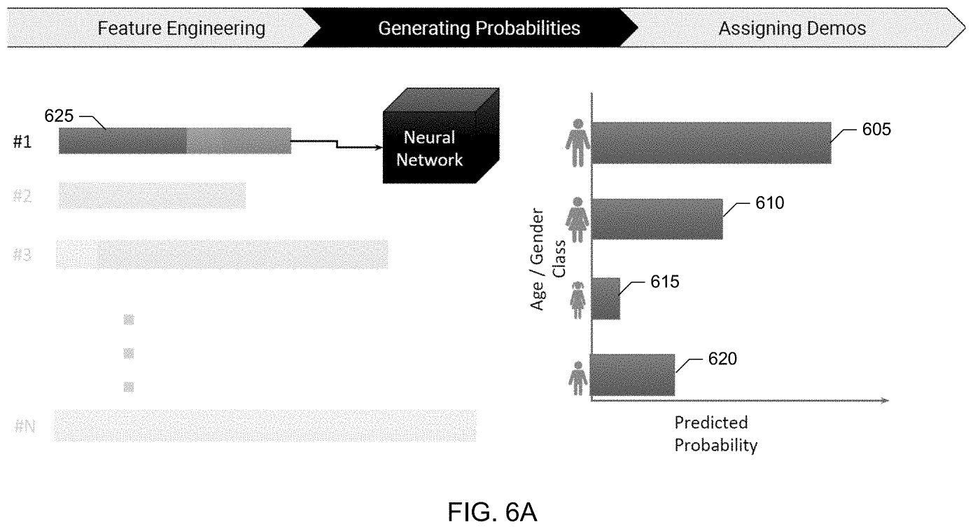

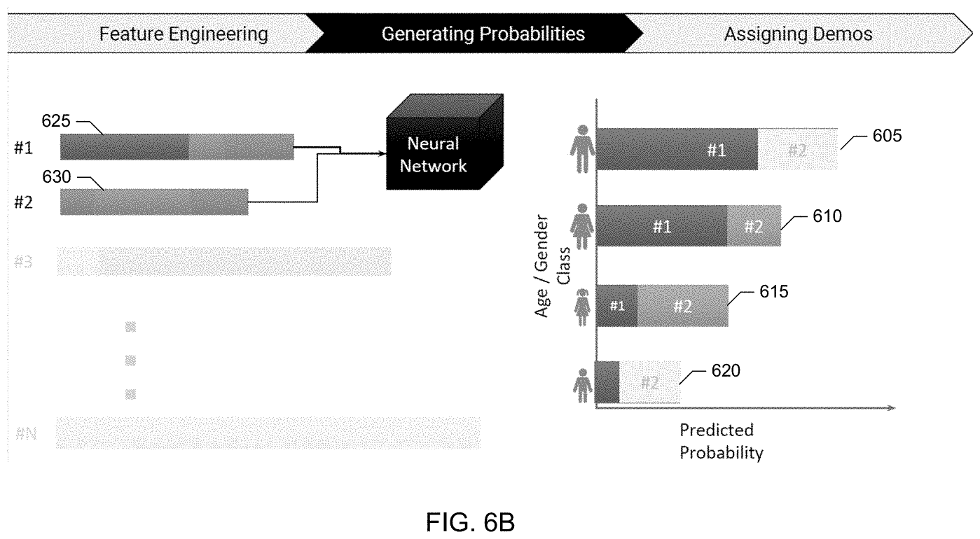

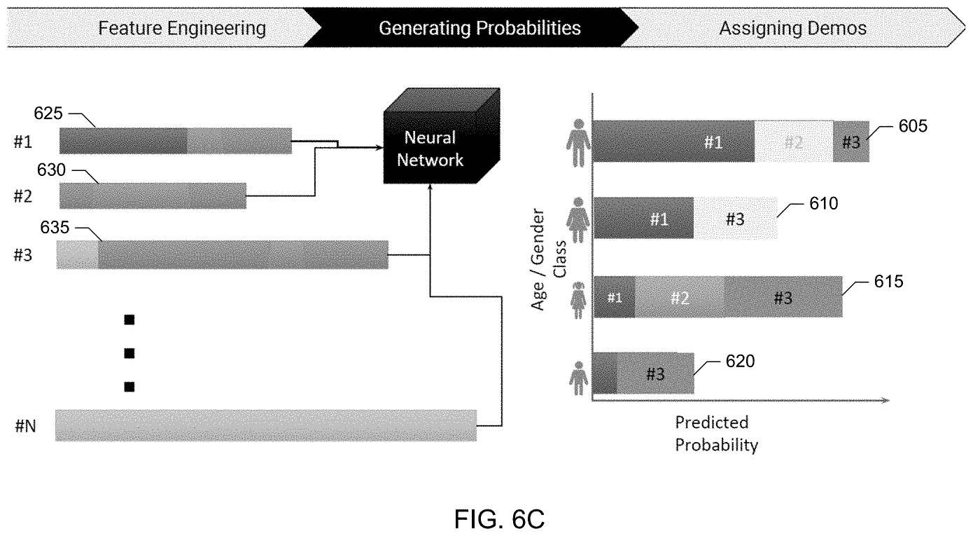

FIGS. 6A-C illustrate an example operation of the demographic prediction neural network 335 to predict demographic target variables 605-620 as feature vectors 625-635 generated from RPD tuning data 145 are applied to the demographic prediction neural network 335 after the demographic prediction neural network 335 has been trained with feature vectors generated from the panelist data 130. In the illustrated example, the demographic prediction neural network 335 is trained by (i) creating view blocks from the panelist tuning data 130 reported for the panelist household, (ii) generating the features for respective ones of the panelist households from the view blocks created for the respective panelist households, as described above, and (iii) applying the features for the respective ones of the panelist households to the neural network 335 according to any training procedure that adjusts the internal parameters of the neural network to reduce an error between the predicted demographic classification probabilities 160 output by the neural network 335 and the actual demographics known for the panelist households. As illustrated in the example of FIGS. 6A-C, as more view blocks are applied to train the neural network 335, the output of the network 335 will converge to predict demographic classification probabilities 160 in line with the actual demographics known for the panelist households.

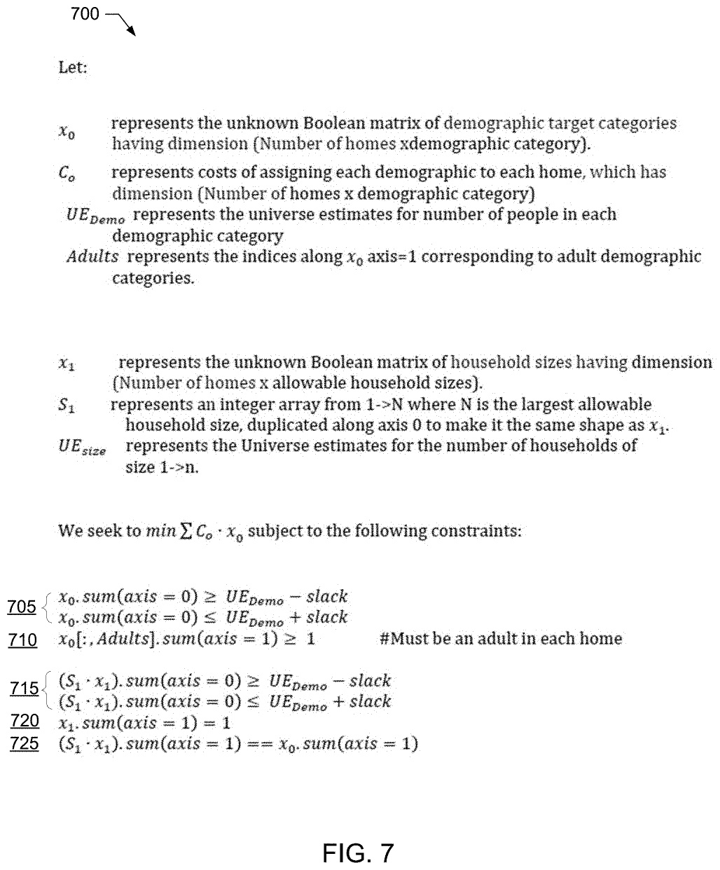

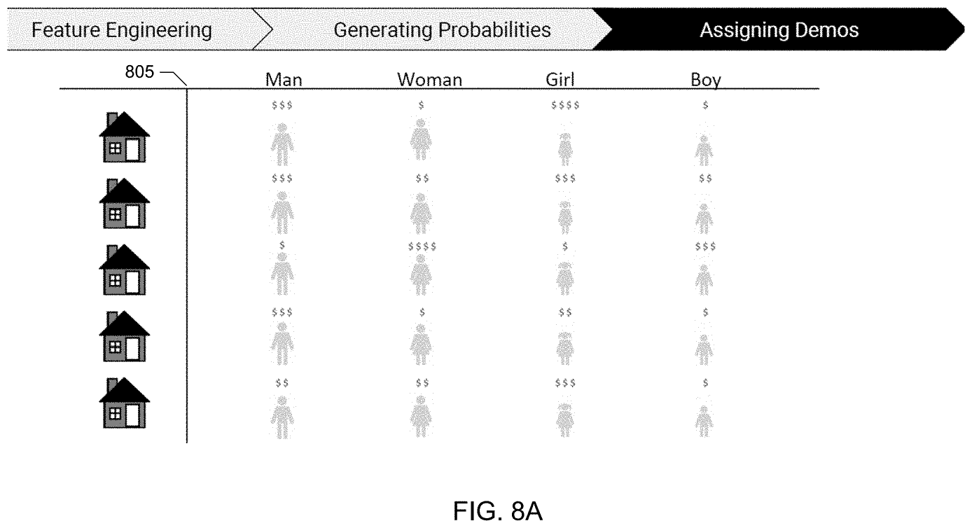

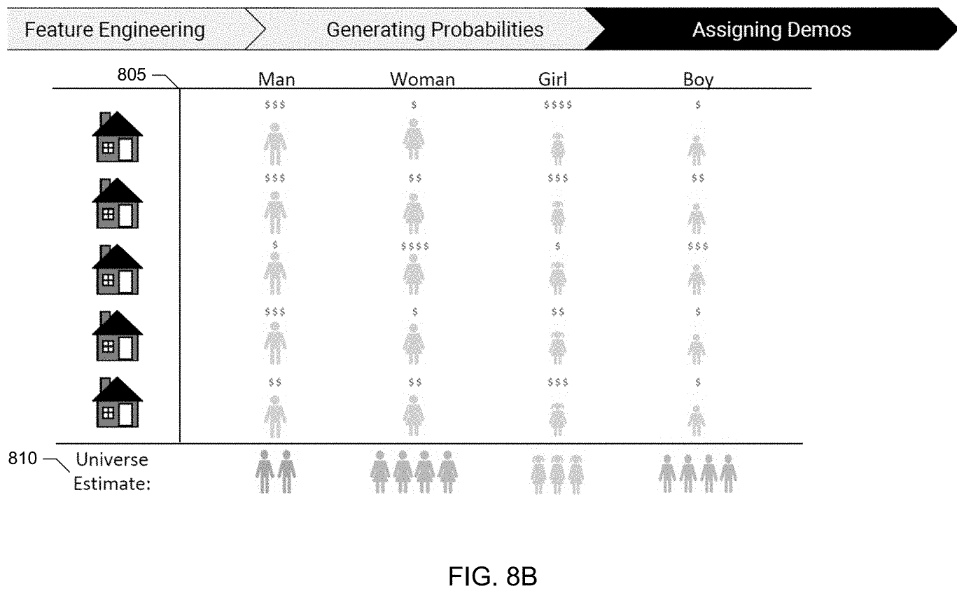

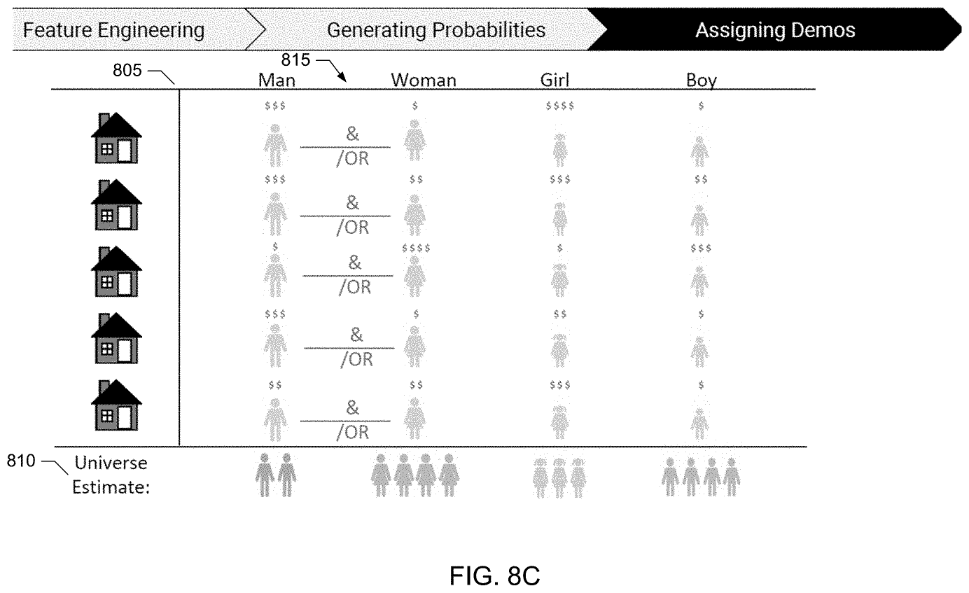

Returning to FIG. 3, the example household demographic assignment engine 340 of the example neural-network-based demographic estimation system 300 uses the estimated demographic classification probabilities (also referred to as the predicted demographic target variables above) output from the demographic prediction neural network 335 to assign demographics to RPD households in accordance with teachings of this disclosure. FIG. 7 illustrates example pseudocode 700 for implementing household demographic assignment engine 340. The example pseudocode 700 also corresponds to an example of the mixed integer programming solution 205 of FIG. 2. In the illustrated example of FIG. 7, the pseudocode 700 to implement the household demographic assignment engine 340 assigns demographics to households by solving an objective function to determine a matrix x0, which is a Boolean matrix that represents the demographic categories assigned to different RPD households, given a cost matrix C0, which represents the cost of assigning different demographic categories to the RPD households, subject to a set of constraints having values stored in the example constraint database 345. In the example of FIG. 7, the matrix x0 is a matrix having a number of rows equal to the number of RPD households, and a number of columns equal to the number of different possible demographic categories that can be assigned to a household. Furthermore, in the illustrated example, for a given row of x0 representing a given RPD household, the elements of the row contain binary (Boolean) variables representing the different possible demographic categories, with the given binary variable representing a given possible demographic category being assigned a value of 1 by the pseudocode 700 if that demographic category is assigned to that RPD household, or being assigned a value of 0 by the pseudocode 700 if that demographic category is not assigned to that RPD household. In the example of FIG. 7, the matrix C0 is also a matrix having a number of rows equal to the number of RPD households, and a number of columns equal to the number of different possible demographic categories that can be assigned to a household. Furthermore, in the illustrated example, for a given row of C0 representing a given RPD household, the elements of the row contain cost variables representing the respective costs for assigning the different possible demographic categories to the given RPD household. In some examples, the costs variables in C0 are determined by the household demographic assignment engine 340 based on the estimated demographic classification probabilities (also referred to as the predicted demographic target variables above) output from the demographic prediction neural network 335. For example, the cost variable for assigning a given possible demographic category to the given RPD household can be determined by the household demographic assignment engine 340 as the inverse (or some other function) of the demographic classification probability for that demographic category and RPD household as determined by the demographic prediction neural network 335.

As illustrated in the example of FIG. 7, the pseudocode 700 employs any mixed integer programming or similar technique to determine the demographic assignment matrix x0 by solving the objective function:

$${\sum }_{i , j} {C}_{0} ( i , j ) \cdot {x}_{0} ( i , j )$$

subject to a set of constraints. The example constraints of FIG. 7 are based on a matrix x1, which is a Boolean matrix representing the different possible household sizes that can be assigned to the different RPD households, and a size matrix S1, which represents the values of the different possible household sizes.

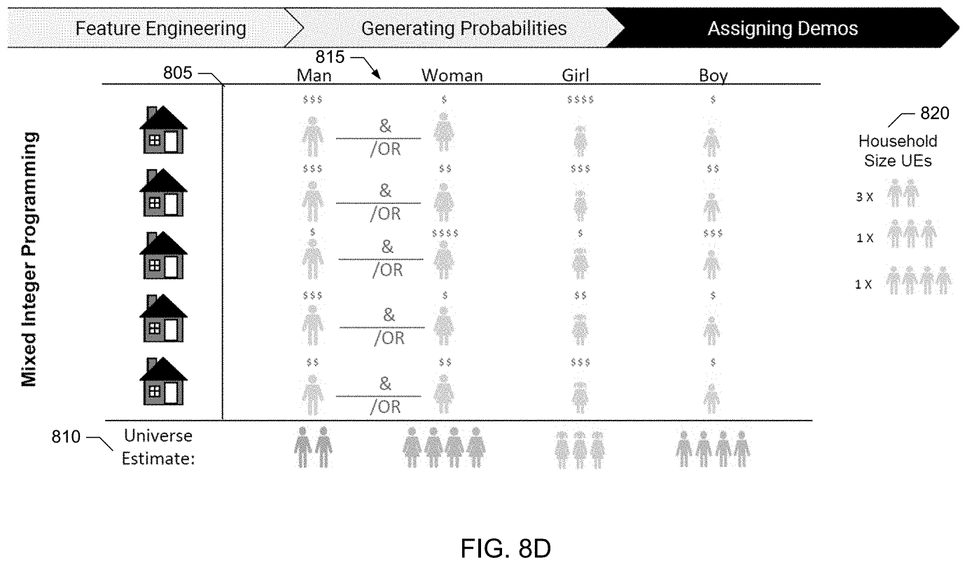

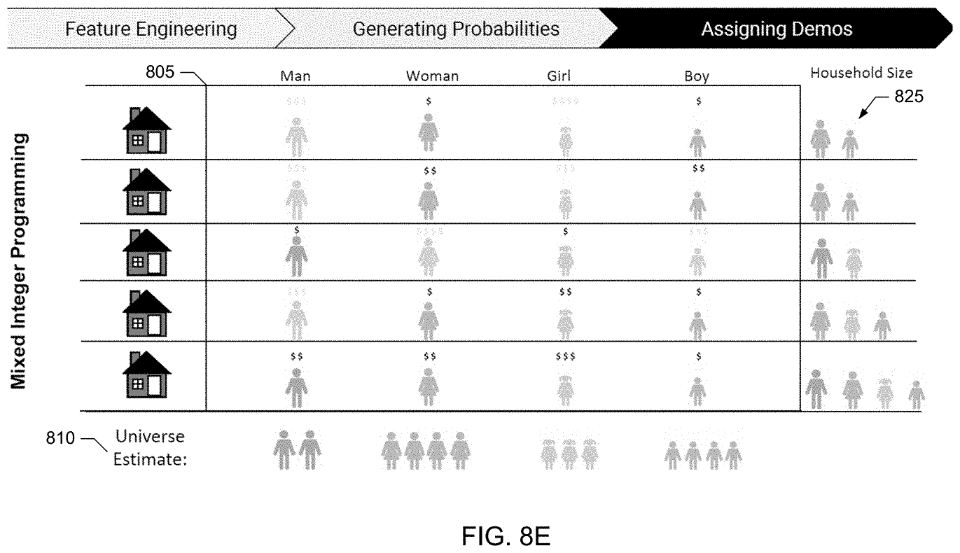

FIGS. 8A-E illustrate an example operation of the household demographic assignment engine 340 implemented by the pseudocode 700 of FIG. 7 to assign demographic categories to RPD households by solving the above expression subject to the example constraints of FIG. 7. FIG. 8A illustrates an example C0 cost matrix 805 having 5 rows representing 5 RPD households for which demographic categories are to be assigned, and 4 columns representing 4 possible demographic categories that could be assigned to respective ones of the RPD households. The cost values for the different possible demographic categories are represented by dollar signs ($) in FIG. 8A, with more dollar signs representing a higher cost. In the illustrated example, costs included in the C0 cost matrix 805 are inversely proportional to the corresponding estimated demographic classification probabilities (also referred to as the predicted demographic target variables above) output from the output layer 525 of the demographic prediction neural network 335 for the given household and demographic category combinations.

Referring to FIGS. 7 and 8A-E, the example constraints of FIG. 7 include a first constraint 705, which specifies that the overall sums of the different demographic categories assigned to all RPD households is to equal the known universe estimates (UEs) for the respective different demographic categories (e.g., within a tolerance level represented by the variable “slack”). An example of the first constraint 705 is illustrated in FIG. 8B, in which the sums of the respective demographic categories assigned over the 5 households are to equal the respective example UEs 810 for the different demographic categories (e.g., which may be obtained from the service provider(s) providing the RPD and stored in the constraint database 345). For example, in FIG. 8B, the first constraint 705 specifies that the number of households to be assigned the demographic category of “man” is to equal the UE of 2 for that demographic category, the number of households to be assigned the demographic category of “woman” is to equal the UE of 4 for that demographic category, the number of households to be assigned the demographic category of “girl” is to equal the UE of 3 for that demographic category, and the number of households to be assigned the demographic category of “man” is to equal the UE of 2 for that demographic category.

The example constraints of FIG. 7 include a second constraint 710, which specifies that there must be at least one adult demographic category assigned to each RPD household. An example of the second constraint 710 is illustrated in FIG. 8B, in which each RPD household is constrained to include the demographic category of “man” and/or the demographic category of “woman” (which is represented by reference numeral 815).

The example constraints of FIG. 7 include a third constraint 715, which specifies that the overall numbers of the different possible household sizes assigned to all RPD households is to equal the known universe estimates (UEs) for the different possible household sizes (e.g., within a tolerance level represented by the variable “slack”). An example of the third constraint 715 is illustrated in FIG. 8D, in which the numbers of the respective possible household sizes assigned over the 5 households are to equal the respective example UEs 820 for the different possible household sizes (e.g., which may be obtained from the service provider(s) providing the RPD and stored in the constraint database 345). For example, in FIG. 8D, the third constraint 715 specifies that the number of households containing two people is to equal the UE of 3 for that household size, the number of households containing three people is to equal the UE of 1 for that household size, and the number of households containing four people is to equal the UE of 1 for that household size.

The example constraints of FIG. 7 include a fourth constraint 720, which specifies that each RPD household is to be assigned just one of the possible household sizes, and a fifth constraint 725, which specifies that the number of different demographic categories assigned to a given RPD household is to equal the household size assigned to that household. FIG. 8E illustrates resulting example demographic category assignments 825 determined by the household demographic assignment engine 340 implemented with the pseudocode 700 of FIG. 7 and given the example constraints 705-725 as illustrated in FIGS. 8A-D. In the example of FIG. 8E, the household demographic assignment engine 340 implemented with the pseudocode 700 solves the expression provided above (and in FIG. 7) subject to the aforementioned constraints to assign: (1) the demographic categories of “woman” and “boy” to the first RPD household, (2) the demographic categories of “woman” and “boy” to the second RPD household, (3) the demographic categories of “man” and “girl” to the third RPD household, (4) the demographic categories of “woman,” “girl” and “boy” to the fourth RPD household, and (5) the demographic categories of “man,” “woman,” “girl” and “boy” to the fifth RPD household. As can be seen in the examples of FIGS. 8A-E, the demographic category assignments 825 satisfy the specified constraints.

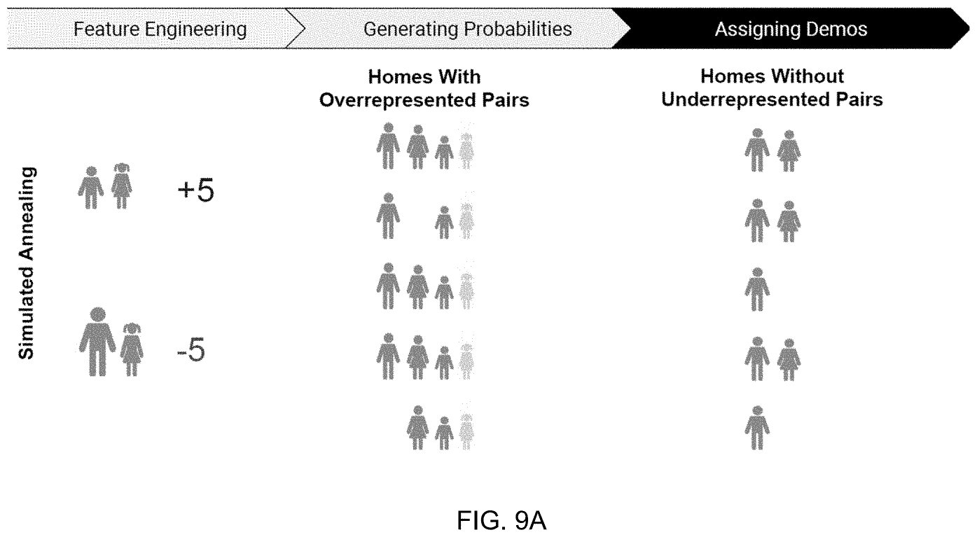

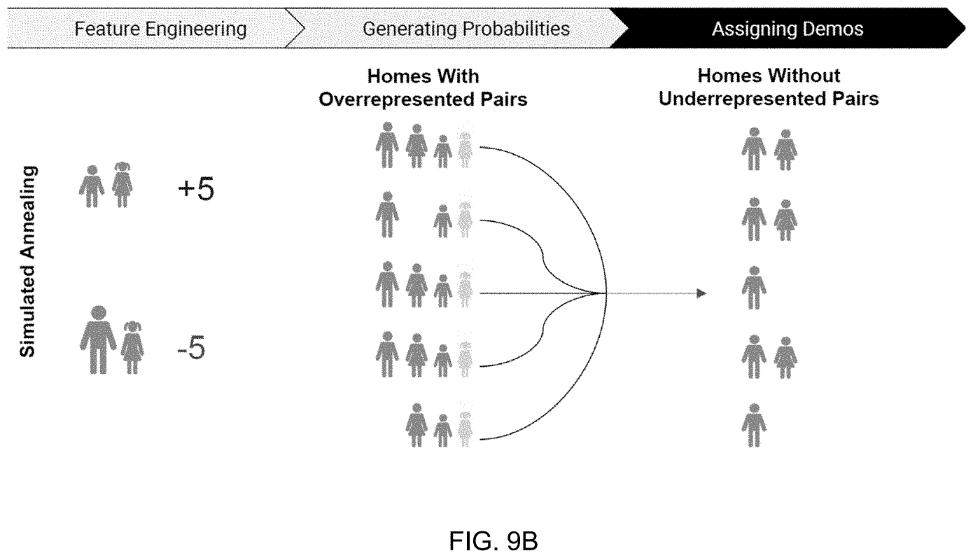

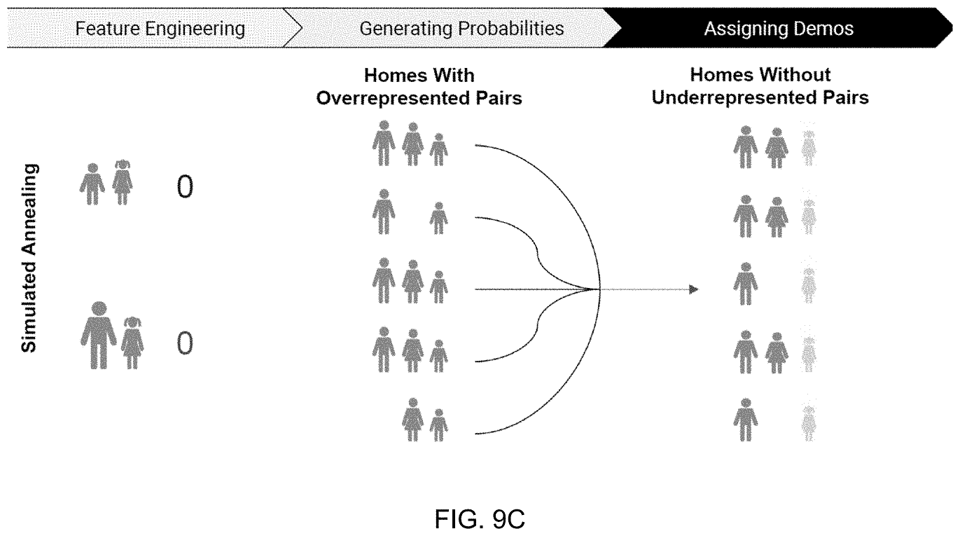

In some examples, the household demographic assignment engine 340 implements simulated annealing to further adjust the demographic category assignments made for the RPD households. An example operation of the household demographic assignment engine 340 to perform simulated annealing is illustrated in FIGS. 9A-C. Turning to FIG. 9A, in the illustrated example, the household demographic assignment engine 340 has performed an initial household demographic assignment in which demographic category assignments containing both “boy” and “girl” are overrepresented relative to UE constraints for that combination of demographic categories by five households, and demographic category assignments containing both “man” and “girl” are underrepresented relative to UE constraints for that combination of demographic categories by five households. As shown in FIGS. 9B-C, the household demographic assignment engine 340 can perform simulated annealing to identify five households containing the overrepresented demographic category assignment of both “boy” and “girl” (see FIG. 9B) and shift the demographic category assignments of “girl” from those households to five households that doe not have a demographic category assignment of both “man” and “girl” (see FIG. 9C). The result is revised demographic category assignments that correct for the overrepresentation and underrepresentation illustrated in FIG. 9A.

In some examples, the household demographic assignment engine 340 breaks the demographic assignment problem illustrated in FIG. 7 into several smaller batches to reduce processing and memory requirements. For example, if a market contains are 100,000 RPD households for which demographic categories are to be assigned, the household demographic assignment engine 340 can break the assignment problem into 100 groups of 1,000 homes, or 1,000 groups of 100 homes, etc. In such examples, the pseudocode 700 of FIG. 7 is adjusted such that the constraints related to universe estimates (UEs) are scaled down by the ratio of the number of RPD households included in the batched groups to the total number of RPD households, and the pseudocode 700 is applied to perform demographic category assignment for each batched group. However, because such simple scaling may not result in solvable constraints for all batched groups, the tolerance levels (e.g., represented by “slack” in FIG. 7) are included to increase the likelihood that each batched group will have a solvable demographic assignment.

Returning to FIG. 3, the neural-network-based demographic estimation system 300 includes the ratings calculator 350 to determine ratings data and/or other audience metrics by using the household demographic assignments determined by the household demographic assignment engine 340 for the RPD households to augment/combine the panel tuning data from the panelist database 315, which already has associated demographic data, with the RPD tuning data from the RPD database 325.

While an example manner of implementing the neural-network-based demographic estimation system 300 is illustrated in FIG. 3, one or more of the elements, processes and/or devices illustrated in FIG. 3 may be combined, divided, re-arranged, omitted, eliminated and/or implemented in any other way. Further, the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example ratings calculator 350 and/or, more generally, the example neural-network-based demographic estimation system 300 of FIG. 3 may be implemented by hardware, software, firmware and/or any combination of hardware, software and/or firmware. Thus, for example, any of the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345, the example ratings calculator 350 and/or, more generally, the example neural-network-based demographic estimation system 300 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example neural-network-based demographic estimation system 300, the example network interface 305, the example panel tuning data collector 310, the panelist database 315, the example RPD data collector 320, the example RPD database 325, the example feature generator 330, the example demographic prediction neural network 335, the example household demographic assignment engine 340, the example constraint database 345 and/or the example ratings calculator 350 is/are hereby expressly defined to include a non-transitory computer readable storage device or storage disk such as a memory, a digital versatile disk (DVD), a compact disk (CD), a Blu-ray disk, etc. including the software and/or firmware. Further still, the example neural-network-based demographic estimation system 300 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

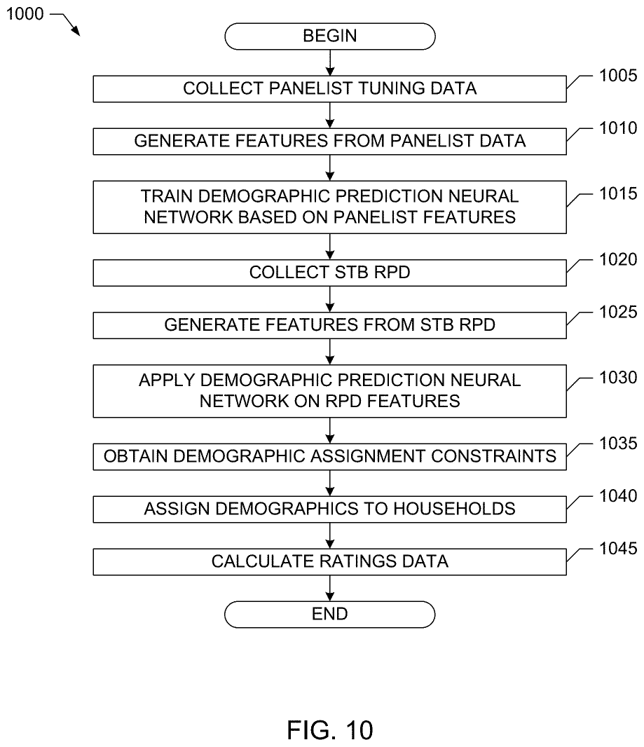

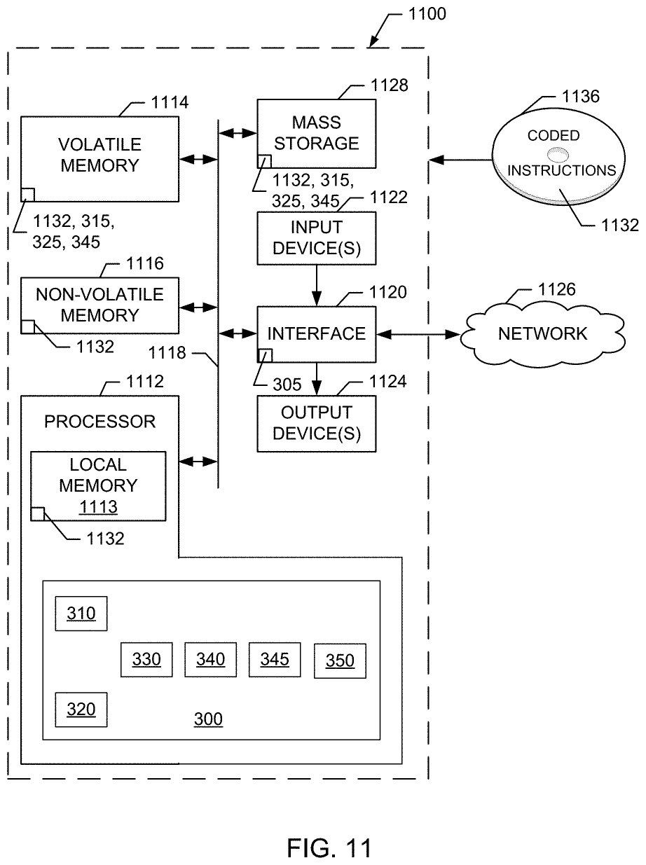

A flowchart representative of example hardware logic, machine readable instructions, hardware implemented state machines, and/or any combination thereof for implementing the example neural-network-based demographic estimation system 300 is shown in FIG. 10. In this example, the machine readable instructions may be one or more executable programs or portion(s) thereof for execution by a computer processor, such as the processor 1112 shown in the example processor platform 1100 discussed below in connection with FIG. 11. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processor 1112, but the entire program or programs and/or parts thereof could alternatively be executed by a device other than the processor 1112 and/or embodied in firmware or dedicated hardware. Further, although the example program(s) is(are) described with reference to the flowchart illustrated in FIG. 10, many other methods of implementing the example neural-network-based demographic estimation system 300 may alternatively be used. For example, with reference to the flowchart illustrated in FIG. 10, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example process of FIG. 10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

An example program 1000 that may be executed to implement the example neural-network-based demographic estimation system 300 of FIG. 3 is represented by the flowchart shown in FIG. 10. With reference to the preceding figures and associated written descriptions, the example program 1000 of FIG. 10 begins execution at block 1005 at which the example panel tuning data collector 310 of the neural-network-based demographic estimation system 300 collects panelist tuning data, as described above. At block 1010, the example feature generator 330 of the neural-network-based demographic estimation system 300 generates feature vectors (e.g., such as the vectors describes in Table 1 above) for the panelist households based on the collected panelist data, as described above. At block 1015, the feature generator 330 applies the panelist feature vectors generated at block 1010 to the example demographic prediction neural network 335 of the neural-network-based demographic estimation system 300 to train the demographic prediction neural network 335 to predict demographic classification probabilities for the respective panelist homes, as described above.

At block 1020, the example RPD data collector 320 of the neural-network-based demographic estimation system 300 collects RPD tuning data, as described above. At block 1025, the example feature generator 330 generates feature vectors (e.g., such as the vectors describes in Table 1 above) for the RPD households based on the collected RPD tuning data, as described above. At block 1030, the feature generator 330 applies the RPD feature vectors generated at block 1025 to the trained demographic prediction neural network 335 of the neural-network-based demographic estimation system 300 to predict demographic classification probabilities for the respective RPD homes, as described above. At block 1035, the example household demographic assignment engine 340 of the neural-network-based demographic estimation system 300 uses the demographic classification probabilities determined at block 1030 to assign demographic categories to respective ones of the RPD households, as described above. At block 1045, the example ratings calculator 350 of the neural-network-based demographic estimation system 300 augments/combines the panel tuning data collected at block 1005, which already has associated demographic data, with the RPD tuning data collected at block 1020 based on the demographic categories assigned to the respective ones of the RPD households at block 1045, as described above.

FIG. 11 is a block diagram of an example processor platform 1100 structured to execute the instructions of FIG. 10 to implement the example neural-network-based demographic estimation system 300 of FIG. 3. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor 1112 may be a semiconductor based (e.g., silicon based) device. In this example, the processor 1112 implements the example panel tuning data collector 310, the example RPD data collector 320, the example feature generator 330, the example demographic prediction neural network 335, the example household demographic assignment engine 340 and the example ratings calculator 350.

The processor 1112 of the illustrated example includes a local memory 1113 (e.g., a cache). The processor 1112 of the illustrated example is in communication with a main memory including a volatile memory 1114 and a non-volatile memory 1116 via a link 1118. The link 1118 may be implemented by a bus, one or more point-to-point connections, etc., or a combination thereof. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface. In this example, the interface circuit 1120 implements the network interface 305.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1100, can allow the user to control the computer system and provide data to the computer using physical gestures, such as, but not limited to, hand or body movements, facial expressions, and face recognition.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives. In some examples, the mass storage device(s) 1128 may implement the panelist database 315, the RPD database 325 and/or the constraint database 345. Additionally or alternatively, in some examples the volatile memory 1114 may implement the panelist database 315, the RPD database 325 and/or the constraint database 345.

The machine executable instructions 1132 corresponding to the instructions of FIG. 10 may be stored in the mass storage device 1128, in the volatile memory 1114, in the non-volatile memory 1116, in the local memory 1113 and/or on a removable non-transitory computer readable storage medium, such as a CD or DVD 1136.

From the foregoing, it will be appreciated that example methods, apparatus and articles of manufacture have been disclosed that implement neural network processing of set-top box return path data to estimate household demographics. An example neural-network-based demographic estimation system 300 disclosed above uses a neural network having a time distributed dense layer (TDDL) followed by a long short term memory (LSTM) recurrent network layer to predict demographic classifications of a households (e.g., panel household for training, and RPD households after training) from viewing data (e.g., panelist tuning data for training, and RPD tuning data after training). The example neural-network-based demographic estimation system 300 groups viewing data for a household into view blocks which describe respective viewing sessions, where a view block indicates the day of the week, the day of the year, the quarter hour of the day, the channel change rate, and the minutes each possible network was viewed. In some examples, viewing blocks are capped at 60 minutes. In some examples, view blocks for a given household are combined and processed by the TDDL to produce a condensed feature set for the viewing sessions of the household. The condensed feature set is then processed by the LSTM to produce a condensed summary feature vector that summarizes the viewing history for the household. The condensed summary feature vector is merged with additional household features, such as total TV consumption, number of view blocks recorded and number of TV tuners in the household, to produce a merged summary feature vector for the household. The merged summary feature vector is then applied to one or more additional hidden layers, which output a classification vector indicating the probability that the household belongs in the different possible demographic classes. Mixed integer programming is then used to solve an objective function based on the demographic classification probabilities output from the neural network, and subject to a set of constraints, to assign one or more demographic categories to respective ones of the RPD households providing the RPD tuning data.

The disclosed methods, apparatus and articles of manufacture improve the efficiency of using a computing device by enabling RPD tuning data to be combined with panelist tuning data in an audience measurement processing system. Combining RPD tuning data with available panel data can greatly increase the amount of data accessible by the audience measurement processing system for predicting audience metrics (e.g., ratings). Such an increased amount of data can improve the statistical completeness of the input data and thereby decrease the associated statistical bias of the results produced by the audience measurement processing system. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A demographic estimation system comprising:
a feature generator to generate features from return path data reported from set-top boxes associated with return path data households;
a neural network to process the features generated from the return path data to predict demographic classification probabilities for the return path data households, the neural network to be trained based on panel data reported from meters that monitor media devices associated with panelist household; and
a demographic assignment engine to assign one or more demographic categories to respective ones of the return path data households based on the predicted demographic classification probabilities.

2. The demographic estimation system of claim 1, wherein the features include a first set of features associated with a first one of the return path data households, and the neural network includes:
a time distributed dense layer to condense the first set of features into a smaller second set of features associated with the first one of the return path data households;
a recurrent neural network layer to process the second set of features;
a merge layer to combine a first feature vector output from the recurrent neural network layer with a third set of features to determine a merged feature vector associated with the first one of the return path data households;
a hidden layer to process the merged feature vector; and
an output layer in communication with the hidden layer to output the predicted demographic classification probabilities associated with the first one of the return path data households.

3. The demographic estimation system of claim 2, wherein the first set of features includes a set of view blocks determined from the return path data reported by a first one of the set-top boxes associated with the first one of the return path data households, respective ones of the view blocks are associated with respective different durations of time, and a first one of the view blocks corresponding to a first one of the durations of time is to identify the first one of the durations of time and media sources tuned by the first one of the set-top boxes during the first one of the durations of time.

4. The demographic estimation system of claim 3, wherein the second set of features includes at least one of a total amount of tuning reported for the first one of the return path data households across the different durations of time, a number of view blocks reported for the first one of the return path data households across the different durations of time, or a total number of tuners included in the first one of the return path data households.

5. The demographic estimation system of claim 1, wherein the demographic assignment engine is to solve an objective function subject to a set of constraints to assign the one or more demographic categories to the respective ones of the return path data households, the objective function based on the predicted demographic classification probabilities.

6. The demographic estimation system of claim 5, wherein:
a first one of the constraints is to constrain respective ones of the demographic categories assigned across the return path data households to sum to respective total estimates for the respective ones of the demographic categories specified by a service provider associated with the return path data;
a second one of the constraints is to constrain respective ones of different possible household sizes assigned across the return path data households to sum to respective total numbers of the respective ones of the different possible household sizes specified by the service provider associated with the return path data; and
a third one of the constraints is to constrain respective numbers of demographic categories assigned to the respective ones of the return path data households to correspond to the respective household sizes assigned to the respective ones of the return path data households.

7. The demographic estimation system of claim 5, wherein the demographic categories correspond to respective second sets of demographic categories assigned to respective the return path data households, and the demographic assignment engine is to perform a simulated annealing procedure on respective first sets of demographic categories assigned to the respective return path data households to determine the second sets of demographic categories.

8. A non-transitory computer readable medium including computer readable instructions that, when executed, cause a processor to at least:
generate features from return path data reported from set-top boxes associated with return path data households;
implement a neural network to process the features generated from the return path data to predict demographic classification probabilities for the return path data households, the neural network to be trained based on panel data reported from meters that monitor media devices associated with panelist household; and
assign one or more demographic categories to respective ones of the return path data households based on the predicted demographic classification probabilities.

9. The computer readable medium of claim 8, wherein the features include a first set of features associated with a first one of the return path data households, and to implement the neural network, the instructions cause the processor to:
implement a time distributed dense layer to condense the first set of features into a smaller second set of features associated with the first one of the return path data households;
implement a recurrent neural network layer to process the second set of features;
implement a merge layer to combine a first feature vector output from the recurrent neural network layer with a third set of features to determine a merged feature vector associated with the first one of the return path data households;
implement a hidden layer to process the merged feature vector; and
implement an output layer in communication with the hidden layer to output the predicted demographic classification probabilities associated with the first one of the return path data households.

10. The computer readable medium of claim 9, wherein the first set of features includes a set of view blocks determined from the return path data reported by a first one of the set-top boxes associated with the first one of the return path data households, respective ones of the view blocks are associated with respective different durations of time, and a first one of the view blocks corresponding to a first one of the durations of time is to identify the first one of the durations of time and media sources tuned by the first one of the set-top boxes during the first one of the durations of time.

11. The computer readable medium of claim 10, wherein the second set of features includes at least one of a total amount of tuning reported for the first one of the return path data households across the different durations of time, a number of view blocks reported for the first one of the return path data households across the different durations of time, or a total number of tuners included in the first one of the return path data households.

12. The computer readable medium of claim 8, wherein the instructions cause the processor to solve an objective function subject to a set of constraints to assign the one or more demographic categories to the respective ones of the return path data households, the objective function based on the predicted demographic classification probabilities.

13. The computer readable medium of claim 12, wherein:
a first one of the constraints is to constrain respective ones of the demographic categories assigned across the return path data households to sum to respective total estimates for the respective ones of the demographic categories specified by a service provider associated with the return path data;
a second one of the constraints is to constrain respective ones of different possible household sizes assigned across the return path data households to sum to respective total numbers of the respective ones of the different possible household sizes specified by the service provider associated with the return path data; and
a third one of the constraints is to constrain respective numbers of demographic categories assigned to the respective ones of the return path data households to correspond to the respective household sizes assigned to the respective ones of the return path data households.

14. The computer readable medium of claim 12, wherein the demographic categories correspond to respective second sets of demographic categories assigned to respective the return path data households, and the instructions cause the processor to perform a simulated annealing procedure on respective first sets of demographic categories assigned to the respective return path data households to determine the second sets of demographic categories.

15. A demographic estimation method comprising:
generating, by executing an instruction with a processor, features from return path data reported from set-top boxes associated with return path data households;
implementing, by executing an instruction with the processor, a neural network to process the features generated from the return path data to predict demographic classification probabilities for the return path data households, the neural network to be trained based on panel data reported from meters that monitor media devices associated with panelist household; and
assigning, by executing an instruction with the processor, one or more demographic categories to respective ones of the return path data households based on the predicted demographic classification probabilities.

16. The method of claim 15, wherein the features include a first set of features associated with a first one of the return path data households, and the implementing of the neural network includes:
implementing a time distributed dense layer to condense the first set of features into a smaller second set of features associated with the first one of the return path data households;
implementing a recurrent neural network layer to process the second set of features;
implementing a merge layer to combine a first feature vector output from the recurrent neural network layer with a third set of features to determine a merged feature vector associated with the first one of the return path data households;
implementing a hidden layer to process the merged feature vector; and
implementing an output layer in communication with the hidden layer to output the predicted demographic classification probabilities associated with the first one of the return path data households.

17. The method of claim 16, wherein the first set of features includes a set of view blocks determined from the return path data reported by a first one of the set-top boxes associated with the first one of the return path data households, respective ones of the view blocks are associated with respective different durations of time, and a first one of the view blocks corresponding to a first one of the durations of time is to identify the first one of the durations of time and media sources tuned by the first one of the set-top boxes during the first one of the durations of time.

18. The method of claim 17, wherein the second set of features includes at least one of a total amount of tuning reported for the first one of the return path data households across the different durations of time, a number of view blocks reported for the first one of the return path data households across the different durations of time, or a total number of tuners included in the first one of the return path data households.

19. The method of claim 15, wherein the assigning of the one or more demographic categories to the respective ones of the return path data households includes solving an objective function subject to a set of constraints to assign the one or more demographic categories to the respective ones of the return path data households, the objective function based on the predicted demographic classification probabilities.

20. The method of claim 19, wherein:
a first one of the constraints is to constrain respective ones of the demographic categories assigned across the return path data households to sum to respective total estimates for the respective ones of the demographic categories specified by a service provider associated with the return path data;
a second one of the constraints is to constrain respective ones of different possible household sizes assigned across the return path data households to sum to respective total numbers of the respective ones of the different possible household sizes specified by the service provider associated with the return path data; and
a third one of the constraints is to constrain respective numbers of demographic categories assigned to the respective ones of the return path data households to correspond to the respective household sizes assigned to the respective ones of the return path data households.
